(19) United States
(12) Patent Application Publication
(10) Pub. No.: US 2006/0034074 A1
(43) Pub. Date: Feb. 16, 2006

(54) Bidirectional flashlight with long-ranged and short-ranged illumination

(76) Inventor: Chen-Hu Ko, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/914,210

(22) Filed: Aug. 10, 2004

(51) Int. Cl. F21L 4/02; F21L 4/04

(52) U.S. Cl. 362/184; 362/205

(57) ABSTRACT

A bidirectional flashlight with long-ranged and short-ranged illumination having a metal tube with a headlight, a tail light, a power supply and a two-way switch wherein the tail light includes an insulating mounting seat within a tail cover with a surrounding lens. A plurality of light-emitting diodes directed to the outside is installed in the mounting seat. Moreover, A negative conductive strip and a positive annular conductive strip lean against an internal wall of the mounting seat and are electrically connected to the negative and the positive terminal of the light-emitting diodes, respectively. A negative connection piece is interposed between the negative conductive strip and the tail cover. A battery positioning reed is attached to a bottom end of the battery chamber while a positive terminal contact piece with a front and a rear contact piece is disposed against the inner wall of the battery chamber. An power supply spring is interposed between a positive terminal of the battery and the power supply connection strip. Besides, a front positive terminal spring is interposed between the tail light connection strip and the front contact piece while a rear positive terminal spring is interposed between the rear contact piece and the positive conductive strip. Furthermore, a negative terminal spring is interposed between the positioning reed and the negative conductive strip.

### BACKGROUND OF THE INVENTION

1. Field of the Invention

The invention relates to a flashlight, and more particularly, to a bidirectional flashlight with long-ranged and short-ranged illumination by means of a single switch to undergo an on-off control thereof.

2. Description of the Related Art

As shown in FIG. 7, a Taiwanese patent application (TW 238725) discloses a bidirectional flashlight that utilizes two flashlights 61-62 with their tails screwed to each other, thereby reaching the effect of bidirectional illumination. Strictly to say, it features two flashlights that are integrated in one body. So, each of the flashlights has its own battery 611-621 set and control switch 612-622, thereby resulting in the increase of its whole length. Meanwhile, the individual on-off-control makes the use complicated. Therefore, it's impractical to use this kind of flashlight.

Long-ranged and short-ranged illumination require different focuses for desired luminous flux. A long-ranged illumination with short-distance focus results in insufficient luminous flux while a short-ranged illumination with long-distance focus create out-of-focus ghost.

### SUMMARY OF THE INVENTION

It is a primary object of the invention to eliminate the aforementioned drawbacks and to provide a flashlight with function of long-ranged and short-ranged illumination while only one switch is employed to undergo an on-off control.

It is another object of the invention to provide a bidirectional flashlight with long-ranged and short-ranged illumination for an optimal illuminating efficiency.

### BRIEF DESCRIPTION OF THE DRAWINGS

The accomplishment of this and other objects of the invention will become apparent from the following descriptions and its accompanying drawings of which:

FIG. 1 is a perspective view of the invention;

FIG. 2 is an axially sectional view of the invention;

FIG. 2A is another an axially sectional view of the invention;

FIG. 3 is an exploded view of a power supply of the invention;

FIG. 4 is a cutaway view of the power supply of the invention;

FIG. 5 is a cutaway view taken along the line V-V of FIG. 2; and

FIG. 6 is a cutaway view taken along the line VI-VI of FIG. 2.

FIG. 7 is a schematic drawing showing the prior art flashlight.

### DETAILED DESCRIPTION OF THE PREFERRED EMBODIMENT

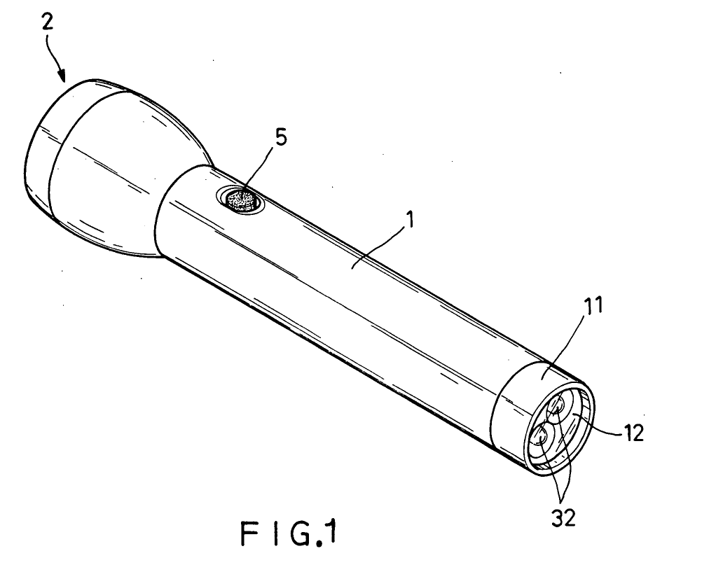

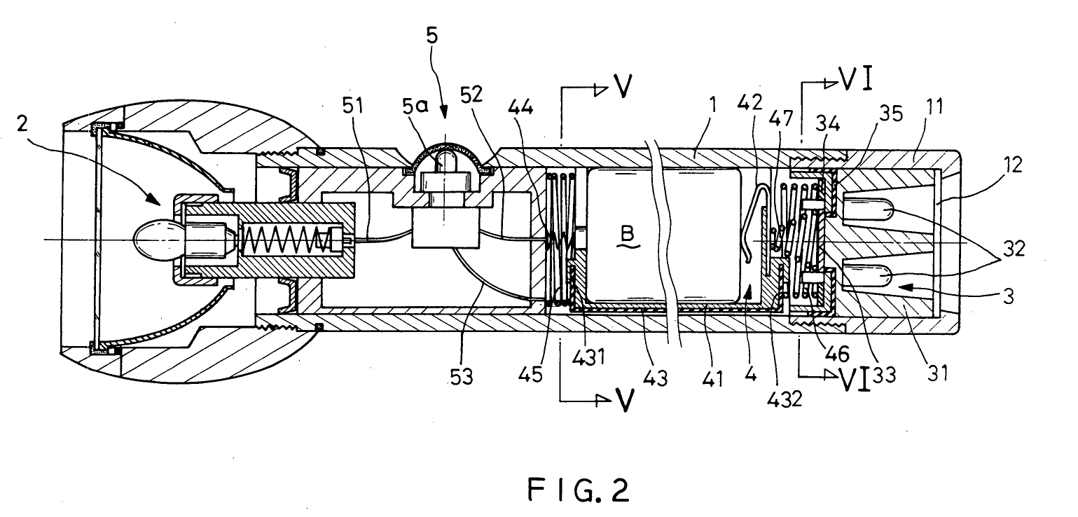

First of all, referring to FIGS. 1 and 2, the flashlight of the invention includes a metal tube 1 having:

a headlight 2 whose negative terminal is directly connected to the metal tube 1;

a tail light 3;

a power supply 4; and

a two-way switch 5 having a headlight connection strip 51, a power supply connection strip 52 and a tail light connection strip 53.

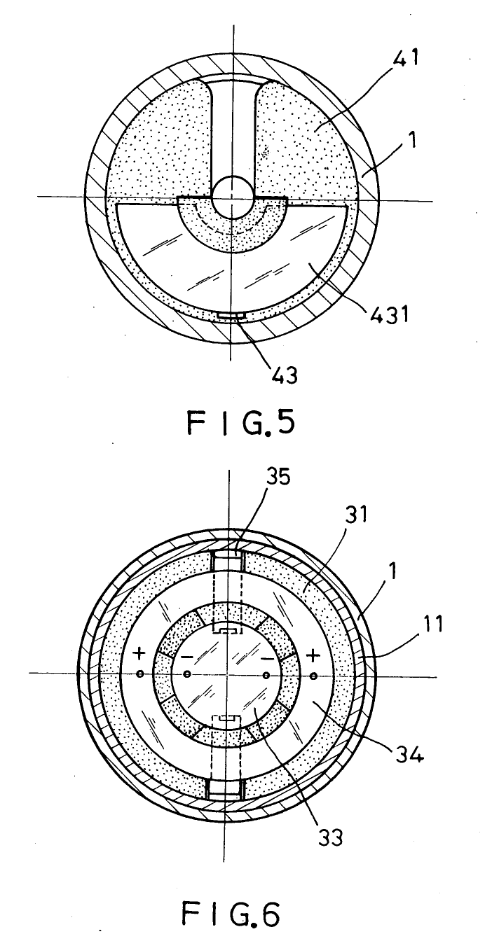

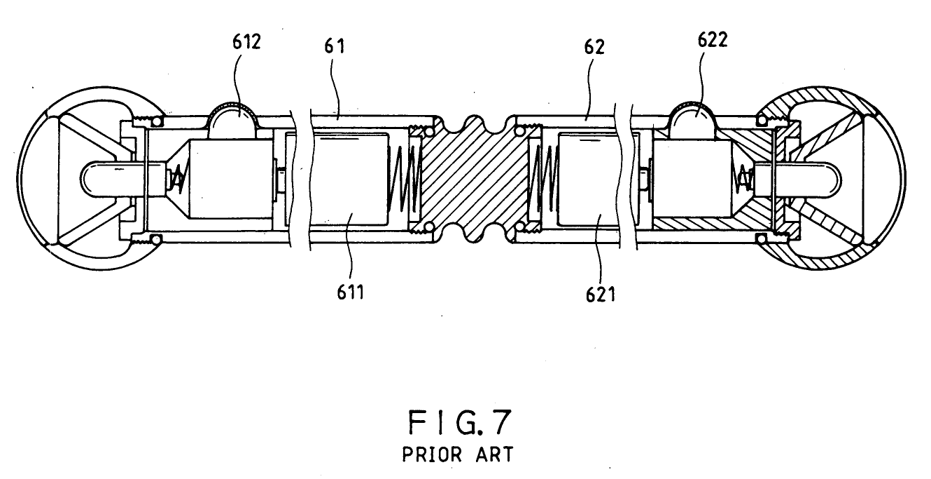

As shown in FIG. 6, the tail light 3 includes an insulating mounting seat 31 within a tail cover 11 with a surrounding lens 12. A plurality of light-emitting diodes 32 directed to the outside is installed in the mounting seat 31. A negative conductive strip 33 and a positive annular conductive strip 34 lean against an internal wall of the mounting seat 31 and are electrically connected to the negative and the positive terminal of the light-emitting diodes 32, respectively. A negative connection piece 35 is interposed between the negative conductive strip 33 and the tail cover 11.

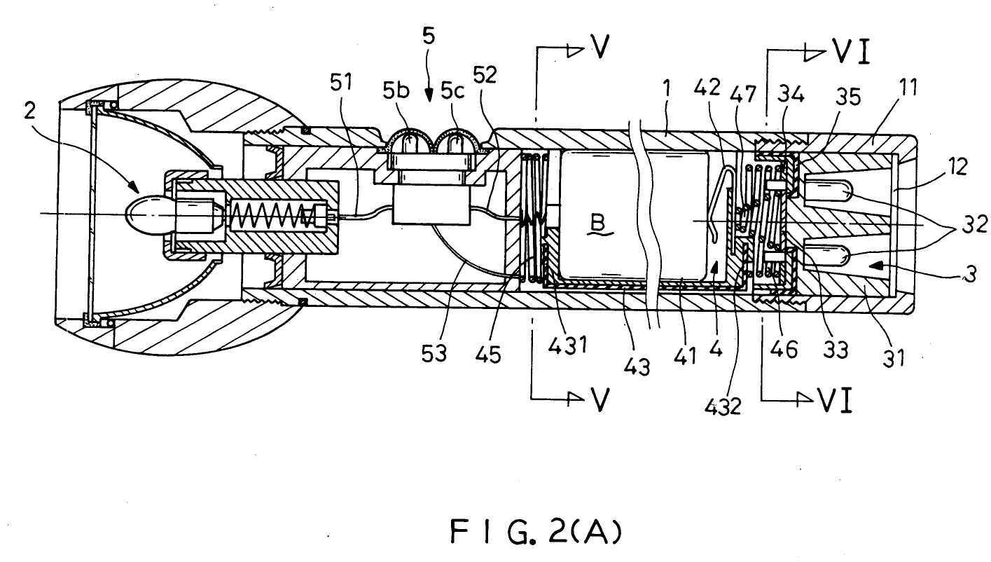

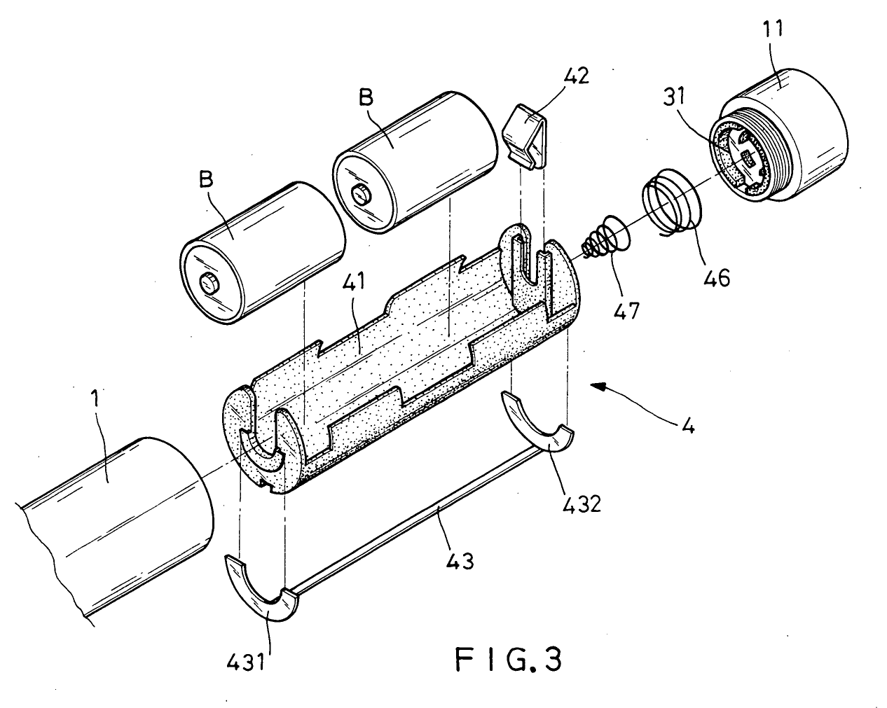

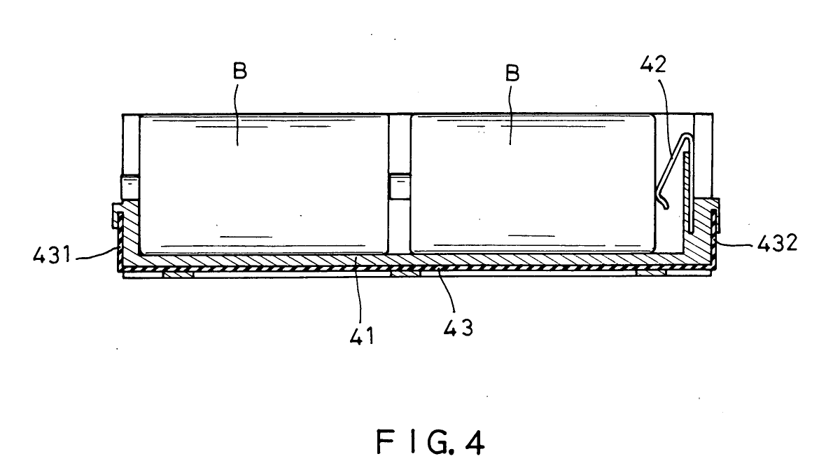

As shown in FIGS. 3 through 5, the power supply 4 has an insulating battery chamber 41 half of which is opened for gaining access to batteries B. A battery positioning reed 42 is attached to a bottom end of the battery chamber 41. Moreover, a positive terminal contact piece 43 with a front and a rear contact piece 431, 432 is disposed against an outer wall of the battery chamber 41. An power supply spring 44 is interposed between a positive terminal of the battery and the power supply connection strip 52. Besides, a front positive terminal spring 45 is interposed between the tail light connection strip 53 and the front contact piece 431 while a rear positive terminal spring 46 is interposed between the rear contact piece 432 and the positive conductive strip 34. A negative terminal spring 47 is interposed between the positioning reed 42 and the negative conductive strip 33.

A first embodiment of the aforementioned two-way switch 5, as shown in FIG. 2, involves a multistage button 5a to control the on-off action of the headlight 2 and tail light 3. A second embodiment of the two-way switch 5, as shown in FIG. 2A, involves two press buttons 5b, 5c to control the on-off action of the headlight 2 and tail light 3, respectively. Except for the single multistage button 5a and the double press button 5b, 5c, the configuration of the switch 5, including the power supply connection strip 52, and the tail light connection strip 53, of both embodiments is identical.

Based on the above-mentioned configuration, a loop of the headlight 2 can be described in a sequence as follows: positive terminal of the battery B=>power supply spring 44=>power supply connection strip 52=>headlight connection strip 51=>headlight 2=>metal tube 1=>tail cover 11=>negative connection piece 35=>negative conductive strip 33=>negative terminal spring 47=>positioning reed 42=>negative terminal of the battery B. In addition, a loop of the tail light 3 can be described in a sequence as follows: positive terminal of the battery B=>power supply spring 44=>power supply connection strip 52=>tail light connection strip 53=>front positive terminal spring 45=>positive terminal contact piece 43=>rear positive terminal spring 46=>positive conductive strip 34=>light-emitting diodes 32 of the tail light 3=>negative conductive strip 33=>negative terminal spring 47=>positioning reed 42=>negative terminal of the battery B.

In this way, the invention requires only one set of the power supply 4 and the two-way switch 5 for the on-off control of the headlight 2 and the tail light 3. Besides, a bidirectional illumination is achieved without prolonging the conventional flashlight. In addition, an easy use is attainable with a two-way switch. Furthermore, the tail light 3 with the light-emitting diodes 32 provides a short-ranged illumination in contrast to a long-range illumination provided by the headlight

Many changes and modifications in the above-described embodiment of the invention can, of course, be carried out without departing from the scope thereof. Accordingly, to promote the progress in science and the useful arts, the invention is disclosed and is intended to be limited only by the scope of the appended claim.

What is claimed is:

1. A bidirectional flashlight with long-ranged and short-ranged illumination comprising:
a) a metal tube;
b) a headlight positioned at one end of the metal tube, the headlight having a negative terminal directly connected to the metal tube;
c) a tail light having an insulating mounting seat within a tail cover with a surrounding lens, a plurality of light-emitting diodes directed to the outside being installed in the mounting seat, a negative conductive strip and a positive annular conductive strip leaning against an internal wall of the mounting seat and being electrically connected to the negative and the positive terminal of the light-emitting diodes, respectively, a negative connection piece being interposed between the negative conductive strip and the tail cover;
d) a two-way switch having a headlight connection strip, a power supply connection strip and a tail light connection strip; and
e) a power supply having an insulating battery chamber half of which is opened for gaining access to batteries, a battery positioning reed being attached to a bottom end of the battery chamber, a positive terminal contact piece with a front and a rear contact piece being disposed against an outer wall of the battery chamber, a power supply spring being interposed between a positive terminal of the battery and the power supply connection strip, a front positive terminal spring being interposed between the tail light connection strip and the front contact piece, a rear positive terminal spring being interposed between the rear contact piece and the positive conductive strip, a negative terminal spring being interposed between the positioning reed and the negative conductive strip.
